(19) United States
(12) Patent Application Publication
(10) Pub. No.: US 2012/0040247 A1
(43) Pub. Date: Feb. 16, 2012

(54) LAYERED COMPOSITE MATERIALS HAVING THE COMPOSITION: (1-x-y)LiNiO2(xLi2Mn03)(yLiCoO2), AND SURFACE COATINGS THEREFOR

(75) Inventors: Venkatesan Manivannan, Fort Collins, CO (US); Joshua R. Buettner-Garrett, Fort Collins, CO (US); Madhu Chennabasappa, Cedex (FR)

(73) Assignee: Colorado State University Research Foundation, Fort Collins, CO (US)

(21) Appl. No.: 13/185,482

(22) Filed: Jul. 18, 2011

Related U.S. Application Data
(60) Provisional application No. 61/365,226, filed on Jul. 16, 2010.

(51) Int. Cl. H01M 4/525; B32B 9/04; C04B 35/64; H01M 4/505

(52) U.S. Cl. 429/223; 428/697; 428/446; 264/658; 252/182.1

(57) ABSTRACT

A straightforward and scalable solid-state synthesis at 975° C. used to generate cathode materials in the system Li₍₃₊ₓ₎₃Ni_{(1-x-y)}Co_{y}Mn_{2x/3}O₂ {a combination of LiNiO₂, Li₂MnO₃, and LiCoO₂ as (1-x-y)LiNiO₂.xLi₂MnO₃.yLiCoO₂} is described. Coatings for improving the characteristics of the cathode material are also described. A ternary composition diagram was used to select sample points, and compositions for testing were initially chosen in an arrangement conducive to mathematical modeling. X-ray diffraction (XRD) characterization showed the formation of an α-NaFeO₂ structure, except in the region of compositions close to LiNiO₂. Electrochemical testing revealed a wide range of electrochemical capacities with the highest capacities found in a region of high Li₂MnO₃ content. The highest capacity composition identified was Li_{1.222}Mn_{0.444}Ni_{0.167}Co_{0.167}O₂ with a maximum initial discharge capacity of in the voltage range 4.6-2.0 V. Differential scanning calorimetry (DSC) testing on this material was promising as it showed an exothermic reaction of 0.2 W/g at 200° C. when tested up to 400° C. Cost for laboratory quantities of material yielded $1.49/Ah, which is significantly lower than the cost of LiCoO₂ due to the low cobalt content, and the straightforward synthesis. Li_{1.222}Mn_{0.444}Ni_{0.167}Co_{0.167}O₂ is thought to be near optimum composition for the specified synthesis conditions, and shows excellent capacity and safety characteristics while leaving room for optimization in composition, synthesis conditions, and surface treatment.

### CROSS-REFERENCE TO RELATED APPLICATIONS

The present application claims the benefit of U.S. Provisional Patent Application No. 61/365,226 for “Metal Oxide Surface-Coated Lithium Nickel Manganese Cobalt Oxide Cathode For Lithium Ion Battery” by Venkatesan Manivannan, which was filed on 16 Jul. 2010, the entire contents of which is hereby specifically incorporated by reference herein for all that it discloses and teaches.

### FIELD OF THE INVENTION

The present invention relates generally to layered oxide composite materials and, more particularly, to layered composite materials having the composition (1-x-y)LiNiO₂.xLi₂MnO₃.yLiCoO₂, and coatings therefor.

### BACKGROUND OF THE INVENTION

Lithium-ion battery technology is currently the most promising energy storage medium for mobile electronics and electric vehicles. The most commonly used cathode material, LiCoO₂, is effective but costly, somewhat toxic, and has lower than desired electrochemical capacity. Although several new material structures have emerged over the last two decades, the LiMO₂ (M=1^{st} row transition metal ion) structure that debuted in the first Sony battery remains the most researched. This material has the layered α-NaFeO₂ structure and R 3̅m space group. Oxygen atoms are disposed in a face-centered cubic close-packed arrangement with the transition metal and lithium ions occupying octahedral sites in alternating layers between the oxygen planes. This structure allows intercalation to occur, where lithium ions are inserted or removed from the structure accompanied by the oxidation or reduction of transition metal ions to maintain charge neutrality.

Despite the success of LiCoO₂, efforts have been made to replace the cobalt with other metals due to the high cost and toxicity of cobalt. Candidates for such substitution include any transition metal or combination of metals having a net oxidation state of +3 that has higher energetically favorable oxidation states. The most common cations explored have been V, Cr, Mn, Fe, Co and Ni. Chromium has oxidation states from +3 to +6, which could allow the presence of inert stabilizing ions in the structure without any loss in capacity, but because of its high toxicity in the oxidized state and poor cyclability, chromium is not widely pursued. Vanadium ions migrate to the lithium sites during charging, preventing the lithium ions from reinserting upon discharge. Similarly, LiFeO₂ also suffers poor reversibility because the deintercalation reaction requires a voltage that is too high for practical use. This leaves manganese, cobalt, and nickel as the most practical choices in LiMO₂.

LiNiO₂ is an attractive cathode material because of its higher discharge capacity (180 mAh/g vs. 140 mAh/g) resulting from its ability to remove a greater proportion of its lithium (˜66% vs. 50%), and a cost savings by replacing cobalt with nickel. However, this material has never approached commercialization because of the difficulty of preparing the material having the proper stoichiometry, since nickel ions tend to migrate into the lithium sites which severely limits its practical capacity. Specific capacity, as used herein, is the amount of charge that can be stored in a given quantity of volume or mass. This problem also affects the reversibility of the intercalation mechanism and leads to capacity fade. Carefully monitored optimized synthesis conditions in an oxygen environment can result in nickel occupying only 1-2% of the lithium sites, but the problem has not been completely eliminated.

Safety is another concern with LiNiO₂ as it has a strong exothermic reaction at relatively low temperatures caused by a combination of the instability of Ni⁺⁴ and the fact that the material can be more delithiated than other materials, as is determined using differential scanning calorimetry (DSC) which measures the amount of heat that is applied externally or released internally as a sample undergoes a constant temperature change. The primary purpose of DSC in battery applications is to find the temperatures at which exothermic reactions occur and to measure the intensities of these reactions.

The most common method of overcoming this problem is by substituting a portion of the nickel in the structure with a different transition metal such as aluminum, titanium, magnesium, cobalt or manganese. Inert substitution ions such as aluminum cap the amount of lithium that can be deintercalated and also increase the binding energy to the oxygen layers to add structural stability during delithiation. Cobalt substitutions ensure a two-dimensional structure and proper nickel location.

DSC investigations show that by substituting for the nickel in LiNiO₂ the major exotherm is moved from around 215° C. to over 300° C. while also decreasing the intensity. Cobalt and manganese substitutions are especially attractive because they help promote proper stoichiometry and stabilize the structure, which improves safety and cyclability without sacrificing capacity. The most commercially successful material in this group has been LiNi_{1/2}Mn_{1/2}O₂, which exhibits electrochemical characteristics similar to LiCoO₂ with improvements in both cost and a milder exothermic reaction. The presence of cobalt in LiNi_{0.8}Co_{0.2}O₂ ensures the proper structure formation and limits the irreversible capacity loss associated with LiNiO₂.

LiMnO₂ and LiMn₂O₄ promise low cost and environmental friendliness offered by manganese, but generate difficulties. LiMnO₂ is difficult to form stoichiometrically because the compound is not stable at the high temperatures needed for direct synthesis. Although successful synthesis has been accomplished by Na⁺ ion exchange and by low temperature methods such as hydrothermal synthesis, such methods add cost and complexity to the process. Additionally, LiMnO₂ reverts to the more stable spinel structure LiMn₂O₄ during cycling. The transformation to this three-dimensional structure with cubic Fd3m space group symmetry occurs once the lithium-to-manganese ratio reaches 1:2.

A combination of the cobalt, nickel, and manganese based materials in LiMnₓNiCo_{(1-x-y)}O₂ permits optimization of the qualities of each. High nickel content generates high capacities; addition of manganese results in increased stability of the structure, and cobalt keeps the nickel ions from entering the lithium layer, which ensures a strictly two-dimensional structure and increases the cost. Too much nickel results in cation mixing, too much manganese can lead to a transformation to the spinel structure, and too much cobalt increases the c/a lattice parameter ratio which decreases capacity. In order to achieve proper stoichiometry in LiMnₓNi_{y}Co_{(1-x-y)}O₂, the average transition metal valence must be +3 with the preferable valences being Co⁺³, Ni⁺², and Mn⁺⁴, which has led to many materials with a Ni/Mn ratio of 1:1. The most commercially successful material of this group has been LiMn_{1/3}Ni_{1/3}CO_{1/3}O₂, which yields a reversible discharge capacity of 150 mAh/g when cycled between 2.5 and 4.2 V, and may reach 220 mAh/g at the cost of poor cyclability when charged to 5.0 V.

Li₂MnO₃ has a layered rock salt structure with monoclinic C2/m symmetry analogous to the layered structure of LiCoO₂, and is considered to be electrochemically inert, as the tetravalent manganese ion cannot be oxidized under practical voltages. Instead, lithium extraction can occur in the form of Li₂O according to the reaction:

Li₂MnO₃→Li₂O+MnO₂

which is not reversible, but one Li⁺ ion can return on discharge to form electrochemically active LiMnO₂. Li₂MnO₃ has a structure similar to LiMO₂ with a partial substitution of Li⁺ in the transition metal layers. That is, lithium ions and Mn ions are disposed in alternating layers, in a 1:2 ratio, separated by layers of cubic close-packed oxygen planes, and therefore may be treated as other layered-type LiCoO₂ and LINiO₂ materials. Adding to the similarity is the equal spacing of the (001) close-packed layers of Li₂MnO₃ and the (003) close-packed layers of LiMO₂ at 4.7 Å. This allows the two materials to be structurally compatible, and Li₂MnO₃ can be rewritten in layered format as Li[Li_{1/3}Mn_{2.3}]O₂. In this form, the material can be viewed in the trigonal R 3̅m space group with Li⁺ in the 3a octahedral site and a 1:2 ratio of Li⁺ and Mn⁴⁺ in the 3b site yielding an average oxidation state of +3.

The structural compatibility of the two materials suggests composites of the form (1-x)Li[Li_{1/3}Mn_{2/3}]O₂.xLiMO₂ or Li[Li_{(1-x)/3}Mn_{(2-2x)/3}Mₓ]O₂, where M is most often Co, Ni, Mn, or a combination thereof. The addition of Li[Li_{1/3}Mn_{2/3}]O₂ in a layered material has an impact on its electrochemical behavior; that is, ion conductivity improves as Li[Li_{1/3}Mn_{2/3}]O₂ has a conductivity in the range of 10⁻⁶ to 10⁻³ S cm⁻¹. Li[Li_{1/3}Mn_{2/3}]O₂ serves addition also changes the way in which the delithiation reaction takes place. At voltages up to about 4.4 V, the ‘M’ ions oxidize as Li⁺ is removed from the LiMO₂ component while no oxidation occurs in the Li[Li_{1/3}Mn_{2/3}]O₂ component. The Li[Li_{1/3}Mn_{2/3}]O₂ serves to stabilize the structure during delithiation because Li⁺ ions from the transition metal layer migrate to the lithium layer to replace the missing ions that had been providing support between the layers. This allows the material to remain stable while undergoing more complete delithiation than is possible with LiMO₂ alone. When charged to higher voltages, lithium is removed from Li[Li_{1/3}Mn_{2/3}]O₂ in the form of Li₂O, which is an irreversible reaction, whereby MnO₂ is left in its place. Half of the lithium removed in this manner will return to form LiMnO₂ upon discharge, but the other half of the lithium contributes to Irreversible Capacity Loss (ICL). This lithium does have benefits, however, as it can compensate for the ICL of the anode material. The material may be “tuned” between capacity and stability.

Li[L_{(1-x)/3}Mn_{(2-x)/3}Ni_{x/3}Co_{x/3}]O₂ is a solid solution of (1-x)Li₂MnO₃ and xLiNi_{1/3}Mn_{1/3}Co_{1/3}O₂, prepared using coprecipitation to generate materials having discharge capacities of 227 mAh/g for x=0.7 and 253 mAh/g for x=0.4, with approximately 0.5 mAh/g lost after each cycle for both materials. While high, the discharge capacities of these materials were much less than the initial charge capacities, showing ICLs of 63 and 75 mAh/g for x=0.7 and x=0.4, respectively. Recent work has been done to reduce or eliminate this ICL. One method is to coat the surface of the particles with Al₂O₃ or another metal oxide in order to limit the cathode material's direct contact with the electrolyte. Another strategy has been to blend the active cathode material with another structure that acts as a lithium host. Both of these methods have been successful in reducing ICL while making small sacrifices in initial charge capacity. The result is a net gain in initial discharge capacity of up to 30 mAh/g. (1-x-y)LiNi_{1/2}Mn_{1/2}O₂.xLi[Li_{1/3}Mn_{2/3}]O₂.yLiCoO₂ is a ternary system designed from studies showing the compatibility of LiNi_{1/2}Mn_{1/2}O₂ and Li[Li_{1/3}Mn_{2/3}]O₂, LiCoO₂ and Li[Li_{1/3}Mn_{2/3}]O₂, and LiCoO₂ and LiNi_{1/2}Mn_{1/2}O₂. The goal of this work was to retain the promising electrochemical results of Li[NiₓLi_{(1/3-2x/3)}Mn_{(2/3-x/3)}]O₂, but to suppress the release of oxygen at high voltages with the addition of Co. Two regions of this system: 0≦x=y≦0.3 and x+y=0.5, were considered. As was expected, increasing values of x and y corresponded to less transition metal occupancy in the lithium layer, along with better cyclability and stability. The best reversible capacities in this system were obtained by materials in 0.3≦x+y≦0.6 at around 200 mAh/g. The best cycling characteristics were obtained from high Li[LiₘMn_{2/3}]O₂ content materials with x≧0.25 and x+y=0.5.

The theoretical capacity for these three-dimensional, layered materials, corresponding to one electron transfer per Li atom from the transition element, is 278 mAh/g. However, intrinsic issues associated with use of these cathode materials in lithium ion batteries have been detrimental in realizing all commercial applications. It has been shown that the electrode/electrolyte interface area was responsible for poor performance, and accordingly, proper control of the physiochemical properties, such as the surface area of the material and the catalytic activity of the electrolytic material, becomes important. Therefore, controlling the surface features and interface may be important for controlling and minimizing side and disproportionate reactions. Additionally, to utilize the highly reversible capacity of cathode materials, charging to voltages on the order of 4.5 V is necessary. However, the reaction of electrodes with electrolyte components at this voltage results in increased interfacial impedance of the materials, ultimately leading to sever capacity loss. To overcome this problem an interface that provides a lower, constant, stable charge transfer resistance between the electrode and electrolyte is necessary.

Coatings with a variety of metal oxide materials for surface modification are known for LiCoO₂, LiMn₂O₄, and LiNi_{0.8}Co_{0.2}O₂. Such an approach was extended to other novel electrode materials, for example, a solution based, Al₂O₃-coated (co-precipitate method) Li[Li_{(1-x)/3}Mn_{(2-x)/3}Co_{x/3}]O₂ cathode, produced a high capacity of 285 mAh/g (2-4.8 V), likely due to suppression of the reaction between particle surface and electrolyte.

### SUMMARY OF THE INVENTION

Embodiments of the present invention overcome the disadvantages and limitations of the prior art by identifying a system of cathode materials having high discharge capacity.

Another object of embodiments of the invention is to provide a method for preparing members of the system of cathode materials having high discharge capacity.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

To achieve the foregoing and other objects, and in accordance with the purposes of the present invention as embodied and broadly described herein, the composition of matter hereof includes a ternary material having the chemical formula: (1-x-y)LiNiO₂.xLi₂MnO₃.yLiCoO₂, where x+y≦1, x≦1, and y≦1.

In another aspect of the present invention, and in accordance with its objects and purposes, the composition of matter hereof consists essentially of a ternary material having the chemical formula: (1-x-y)LiNiO₂.xLi₂MnO₃.yLiCoO₂, where x+y≦1, x≦1, and y≦1.

In yet another aspect of the present invention, and in accordance with its objects and purposes, the cathode hereof includes an active ternary material consisting essentially of material having the chemical formula (1-x-y)LiNiO₂.xLi₂MnO₃.yLiCoO₂, where x+y≦1, x≦1, and y≦1.

In still another aspect of the present invention, and in accordance with its objects and purposes, the cathode hereof includes an active material including a ternary material having the chemical formula (1-x-y)LiNiO₂.xLi₂MnO₃.yLiCoO₂, where x+y≦1, x23 1, and y≦1.

In another aspect of the present invention, and in accordance with its objects and purposes, the cathode hereof consists essentially of an active ternary material having the chemical formula: (1-x-y)LiNiO₂.xLi₂MnO₃.yLiCoO₂, where x+y≦1, x≦1, and y≦1, a conductive additive, and a binder.

In yet another aspect of the present invention, and in accordance with its objects and purposes, the method hereof for preparing active ternary cathode materials having the chemical formula (1-x-y)LiNiO₂.xLi₂MnO₃.yLiCoO₂, where x+y≦1, x≦1, and y≦1, includes the steps of mixing stoichiometric quantities of acetates of lithium, manganese, nickel and cobalt; grinding the mixture of acetates to achieve intimate mixing; heating the mixture to a first temperature effective for decomposing the acetates; after allowing the heated mixture to cool, grinding the cooled mixture to a homogeneous powder; pressing the powder into a pellet; heating the pellet to a second temperature effective for phase formation and low enough to avoid decomposition; and quenching the heated pellet in liquid nitrogen.

Benefits and advantages of embodiments of the present invention include, but are not limited to, providing cathode materials having an initial discharge capacity and cycling capability superior to those of currently commercialized lithium-ion cathode materials.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a ternary composition diagram of (1-x-y)LiNi_{0.8}Co_{0.2}O₂.xLi₂MnO₃.yLiCoO₂, showing the points chosen for testing.

FIG. 2 shows XRD patterns of compositions 1-8 for the (1-x-y)LiNi_{0.8}Co_{0.2}O₂.xLi₂MnO₃.yLiCoO₂ system.

FIG. 3A shows initial charge-discharge curves for compositions 2-5, while FIG. 3B shows initial charge-discharge curves for compositions 6-8.

FIG. 4 is a ternary composition diagram of Li_{(3+x)/3}Ni_{(1-x-y)}Co_{y}Mn_{2x/3}O₂ and the points chosen for testing.

FIG. 5 shows XRD patterns of Li_{(3+x)/3}Ni_{(1-x-y)}Co_{y}Mn_{2x/3}O₂ compositions 1-10.

FIG. 6A shows the initial charge-discharge curves of Li_{(3+x)/3}Ni_{(1-x-y)}Co_{y}Mn_{2x/3}O₂ compositions 2-6, while FIG. 6B shows the initial charge-discharge curves of Li_{(3+x)/3}Ni_{(1-x-y)}Co_{y}Mn_{2x/3}O₂ compositions 7-10.

FIG. 7 shows the initial discharge capacity curves for the Li_{(3+x)/3}Ni_{(1-x-y)}Co_{y}Mn_{2x/3}O₂ system illustrated in FIGS. 6A and 6B hereof plotted on a single graph.

FIG. 8 shows a DSC scan of uncharged Sample #6 cathode material.

FIG. 9 is a DSC scan of Sample #6 cathode with electrolyte charged to 4.5 V.

FIG. 10 shows DSC scans of Sample #6 and LiNiO₂ cathodes with electrolyte charged to 4.5 V.

FIG. 11A shows a mixture analysis fitting a full cubic model to the ten data points to project initial discharge capacities throughout the diagram, where values are in mAh/g, while FIG. 11 B shows a mixture analysis fitting a full cubic model to the ten data points of Li_{(3+x)/3}Ni_{(1-x-y)}Co_{y}Mn_{2x/3}O₂ plus the eight points from (1-x-y)LiNi_{0.8}Co_{0.2}O₂.xLi₂MnO₃.yLiCoO₂ to project initial discharge capacities throughout the diagram, where values are again in mAh/g.

FIG. 12 illustrates the discharge profiles for the coatings Al₂O₃ (a), ZnO (b) and a comparison of the first discharge for Al₂O₃, ZnO, and AlPO₄ (c), on Li_{1.222}Mn_{0.444}Ni_{0.167}Co_{0.167}O₂ charged to 4.6 V.

FIG. 13 illustrates extended life testing for Al₂O₃ (a), AIPO₄ (b), and ZnO (c), where M6≡Li_{1.222}Mn_{0.444}Ni_{0.167}Co_{0.167}O₂, the filled symbols represent testing performance at 0.1 mA/cm², and the open symbols represent testing conditions at 0.3 mA/cm².

FIG. 14 illustrates DSC performed on uncoated (circles) and coated (solid line) Li_{1.222}Mn_{0.444}Ni_{0.167}Co_{0.167}O₂ in the temperature range between 30° C. and 400° C., along with results for LiNiO₂ (squares), where the inset shows DSC results for uncoated (circles) Li_{1.222}Mn_{0.444}Ni_{0.167}Co_{0.167}O₂ and Al₂O₃-coated Li_{1.222}Mn_{0.444}Ni_{0.167}Co_{0.167}O₂ (solid line), all charged in a 1M LiPF₆ EC:DMC electrolyte.

### DETAILED DESCRIPTION OF THE INVENTION

Briefly, embodiments of the present invention include a method for and easily-scaled solid state synthesis for cathode materials in the system (1-x-y)LiNiO₂.xLi₂MnO₃.yLiCoO₂, or structurally Li_{(3+x)/3}Ni_{(1-x-y)}Co_{y}Mn_{2x/3}O₂, x+y≦1, x≦1, and y≦1, as is described in more detail in “Optimization And Characterization Of Lithium-Ion Cathode Materials In The System Li_{(3+x)/3}Ni_{(1-x-y)}Co_{y}Mn_{2x/3}O₂,” Master of Science Thesis of Joshua Garrett, Colorado State University, Fall 2009, the disclosure and teachings of which are hereby incorporated by reference herein. This system is a combination of the materials LiNiO₂, Li₂MnO₃, and LiCoO₂. A ternary composition diagram was used to select sample points, and compositions for testing were chosen for ease of mathematical modeling. All materials were synthesized with the same conditions at 975° C. Each chosen sample was characterized by X-ray diffraction (XRD) scans and electrochemical testing which showed the formation of the α-NaFeO₂ structure, except in the region of compositions close to LiNiO₂. Electrochemical testing revealed a wide range of electrochemical capacities with the highest capacities found in a region of high Li₂MnO₃ content. The composition having highest capacity was Li_{1.222}Mn_{0.444}Ni_{0.167}Co_{0.167}O₂ with a maximum initial discharge capacity of in the voltage range 4.6-2.0 V, which discharge capacity and other properties, such as good cycling capability are superior to those of currently commercialized lithium-ion cathode materials. Differential scanning calorimetry (DSC) testing on this material showed an exothermic reaction of 0.2 W/g at 200° C. when tested up to 400° C. Cost of materials for laboratory quantities yielded $1.49/Ah. This is significantly lower than the cost of LiCoO₂ due to the low cobalt content. Additional cost benefits are obtained by the simple synthesis method. Mixture analysis for fitting a full cubic model to the collected data and map capacities showed an optimized composition and capacity very close to the best sample in initial testing. Therefore, Li_{1.222}Mn_{0.444}Ni_{0.167}Co_{0.167}O₂, is thought to be near the optimum composition for the specified synthesis conditions. This material is especially promising because it shows excellent capacity and safety characteristics while also leaving more room for optimization in composition, synthesis conditions, and surface treatments.

In order to further enhance the performance of these materials various coatings, such as metal oxides (MO=Al₂O₃, AlPO₄, ZnO, CeO₂, ZrO₂, and SiO₂), were investigated. A solution based process was employed. The coated materials were then characterized for structural property relationships, the electrochemical performance of Li_{1.222}Mn_{0.444}Ni_{0.167}Co_{0.167}O₂ illustrating that the MO-coated materials have decresed ICL (irreversible capacity loss) and improved discharge capacity (>4% improvement) with good cycling under the same test conditions.

Dopants may also be added to increase conductivity, add structural stability (which improves cycle life and thermal stability), and/or prevent metal ion dissolution. Common dopants would include: Al, Mg, Zr, Ti, Sn, and Cu. It is expected that concentrations would be in the range between about 0 and 0.06 units (for example, there are 0.8 units of Ni in LiNi_{0.8}Co_{0.2}O₂); significantly more dopant might deleteriously decrease the active material.

Initial capacity and cost are important attributes of any cathode material because other metrics such as cyclability, discharge rate, and safety can be improved through treatments such as surface coatings, particle size control, changing charge profiles, and others. Therefore, tests and analyses were undertaken to determine combinations of high capacity and low cost. Any material in the presented system will have an advantage over LiCoO₂ in terms of cost due to the substitution of cobalt with the less expensive manganese, nickel, and lithium. Therefore, materials having high initial capacity should show promise for commercialization.

As stated hereinabove, composites containing Li₂MnO₃.LiNi_{1/2}Mn_{1/2}O₂, LiNi_{1/3}Mn_{1/3}Co_{1/3}O₂, and LiCoO₂ have been shown to integrate well with Li₂MnO₃, which led to the development of quasi solid solution compositions within the (1-x-Y)LiNi_{1/2}Mn_{1/2}O₂.xLi[Li_{1/3}Mn_{2/3}]O₂.yLiCoO₂ system. With the replacement of the LiNi_{1/2}Mn_{1/2}O₂ with the higher capacity LiNi_{0.8}Co_{0.2}O₂, the (1-x-y)LiNi_{0.8}Co_{0.2}O₂.xLi₂MnO₃.yLiCoO₂ system was developed by the present inventors. was expected that the reactivity of LiNi_{0.8}Co_{0.2}O₂ under elevated temperatures and its stability and safety issues might be improved when the high initial capacity of LiNi_{0.8}Co_{0.2}O₂ is combined with the stability offered by Li₂MnO₃ and the ease of proper synthesis of LiCoO₂, as is described in “Optimization and Characterization of Lithium Ion Cathode Materials in the System (1-x-y)LiNi_{0.8}Co_{0.2}O₂.xLi₂MnO₃.yLiCoO₂” by Venkatesan Manivannan et al., Energies 2010, 847-865 (21 Apr. 2010), this paper hereby being incorporated by reference herein for all that it discloses and teaches. LiCoO₂ is itself more stable but, in addition, the Co tends to prevent the migration of Ni to the Li sites and to form the correct structure. Electrochemically inert Li₂MnO₃ is added to further improve stability and safety, as discussed hereinabove.

In deciding what components should make up a ternary system, materials having compatible structures were combined where each offers properties that compliment those of the other materials.

All samples were made using solid state synthesis methods. For the Li_{(3+x)/3}Ni_{(1-x-y)}Co_{y}Mn_{2x/3}O₂ system, the acetates Li—(COOCH₃)₂.2H₂O, Mn—(COOCH₃)₂.4H₂O, Ni—(COOCH₃)₂.4H₂O, and Co—(COOCH₃)₂.4H₂O as received from Alfa Aesar were used as precursor materials. Acetates require two heating stages, but obtaining a pure phase product was found to be more certain. Stoichiometric amounts of the precursors were measured out, typically in six gram batches. Intimate mixing and particle size control was done through grinding with a mortar and pestle. When a fine, homogeneous powder was obtained, the mixture was placed in a covered porcelain crucible and heated to 450° C. in air for 10 h. This step allows the acetates to burn off, but the desired phase will not form at these low temperatures. The product was again ground by hand and pressed into a pellet using approximately 1800 psi (12.4 MPa). The pellet was placed in a porcelain crucible before a second heating cycle of 975° C. for 4 h. The higher temperature was needed because of the wide range of compositions tested in the material system. The temperature chosen had to be sufficiently high to ensure proper phase formation, but low enough to avoid undesired decomposition. Immediately following the heating cycle, the material was submerged in liquid nitrogen for quenching. The material was collected and stored in a dry environment until made into a cathode.

Following synthesis, the material pellets were again ground by hand and sieved to ensure a maximum particle agglomeration of 44 μm. Cathodes made for lab testing were ½ in. diameter discs composed of approximately 75% active material, about 20% of a conductive additive, such as acetylene black or another carbon black, as examples and approximately 5% of a binder, such as polytetrafluoroethylene (PTFE) or polyvinylidene fluoride (PVDF), as examples. The active material and conductive additive were weighed and ball milled together to achieve uniform mixing. Suspended PTFE was then added, and the mixture was allowed to dry overnight in a dry low-temperature oven. Once dry, the mixture was homogenized and rolled into malleable sheets. A ½ in. diameter punch was used to harvest electrodes from areas of the sheet with no visible imperfections. Uniform cathode thickness was obtained by using a target cathode weight along with the known area. A cathode can be repeatedly rolled and punched until the target weight is achieved. This method differs from that used in industry. The disc cathodes are thicker than coated electrodes and must be placed firmly against a current collector rather than being bonded directly. These factors can lower the ion diffusivity and electrical conductivity of the cell, and slightly improved electrochemical results can be expected with the coating method.

Having generally described embodiments of the invention, the following EXAMPLES provide further details.

### EXAMPLE 1

### (1-x-y)LiNi_{0.8}Co_{0.2}O₂xLi₂MnO₃.yLiCoO₂

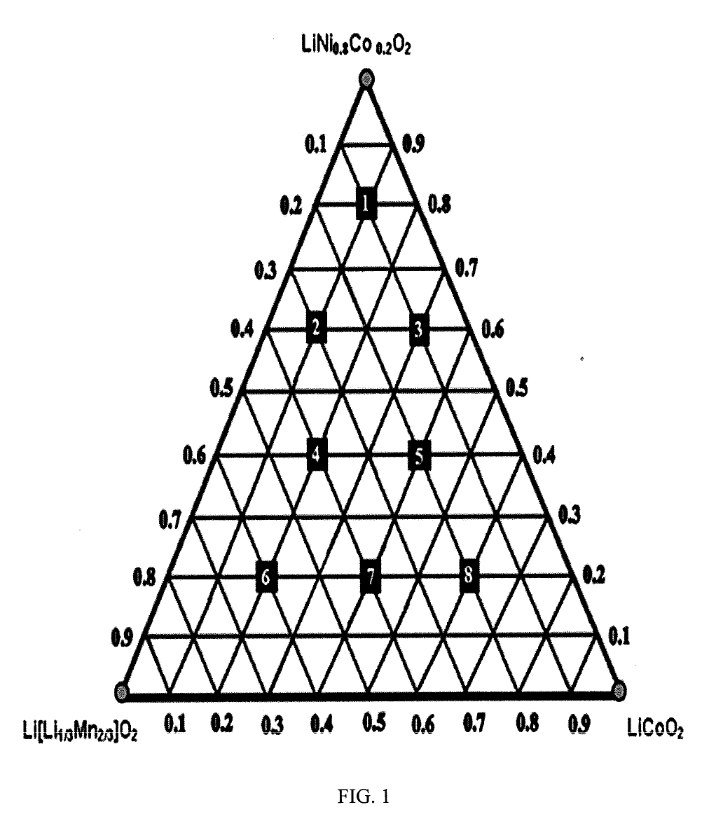

Reference will now be made in detail to the present embodiments of the invention, examples of which are illustrated in the accompanying drawings. Turning now to FIG. 1, shown is a ternary composition diagram where points were chosen within the diagram in search of trends and to develop an optimized material. Preliminary characterization such as XRD was performed on all samples to show that single-phase materials were being made, but more extensive techniques such as differential scanning calorimetry were limited to the most promising materials.

The lever rule can be applied to determine the composition of a material at any point of a ternary composition diagram. The perpendicular distance from one of the points is an indication of how much of the corresponding material is present. The compositions of the sample points are given in TABLE 1 for (1-x-y)LiNi_{0.8}Co_{0.2}O₂.xLi₂MnO₃.yLiCoO₂.

TABLE 1

| Location | Composition |
|---|---|
| 1 | Li_{1.033}Mn_{0.067}Ni_{0.640}Co_{0.26}O₂ |
| 2 | Li_{1.100}Mn_{0.200}Ni_{0.480}Co_{0.220}O₂ |
| 3 | Li_{1.033}Mn_{0.067}Ni_{0.480}Co_{0.420}O₂ |
| 4 | Li_{1.133}Mn_{0.267}Ni_{0.320}Co_{0.280}O₂ |
| 5 | Li_{1.067}Mn_{0.133}Ni_{0.320}Co_{0.480}O₂ |
| 6 | Li_{1.200}Mn_{0.400}Ni_{0.160}Co_{0.240}O₂ |
| 7 | Li_{1.133}Mn_{0.267}Ni_{0.160}Co_{0.440}O₂ |
| 8 | Li_{1.067}Mn_{0.133}Ni_{0.160}Co_{0.640}O₂ |

As is seen from TABLE 1, most of the explored compositions had high nickel content because of the tendency of such compositions to have high initial capacities, assuming proper synthesis is possible.

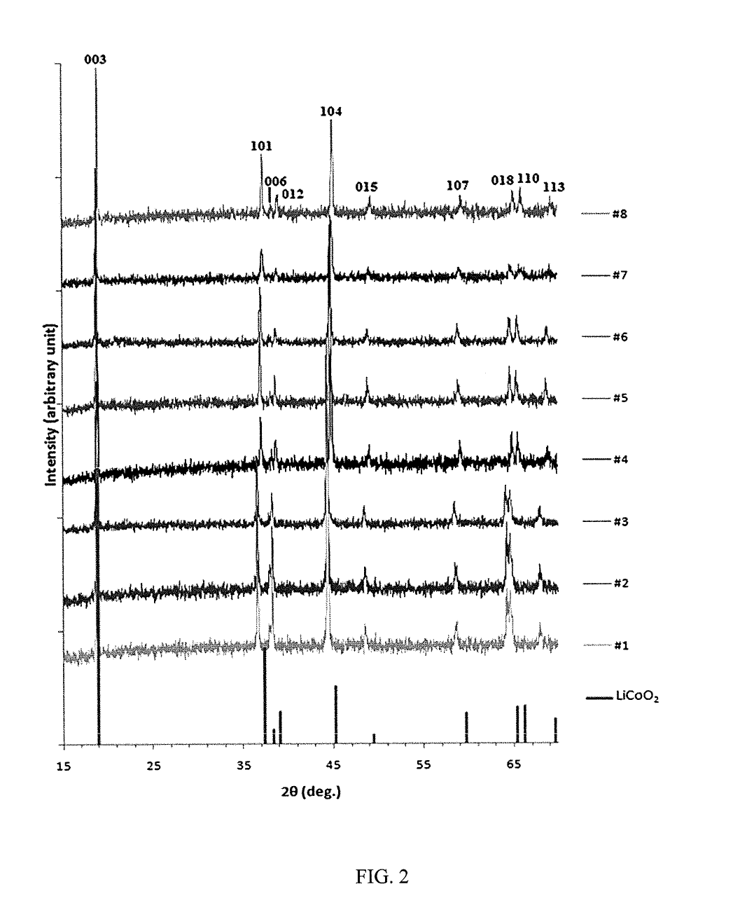

FIG. 2 shows XRD plots for compositions 1-8 of the (1-x-y)LiNi_{0.8}Co_{0.2}O₂.xLi₂MnO₃.yLiCoO₂ system. All samples established an α-NaFeO₂ structure with varying degrees of crystallinity. As described hereinabove, compositions close to LiNiO₂ require special synthesis conditions to form that were not met by the constant synthesis conditions used, with consequent formation of a significant NiO component, rendering the material unusable. There is an apparent lack of the superlattice ordering in the range of 20-25° that is indicative of monoclinic Li₂MnO₃, which might be caused by a partial lithium deficiency stemming from the high temperature synthesis.

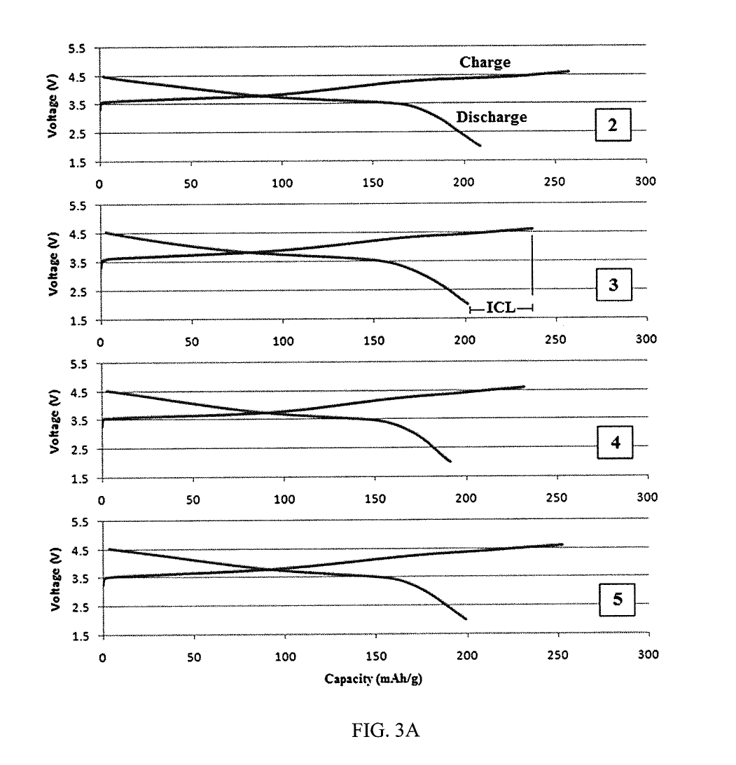

All electrochemical testing was done using an Arbin BT2000 battery testing system and MITS Pro Arbin software. Half cells were constructed for testing, such that only the cathode had a limiting effect on the cell performance, and were cycled between 2 and 4.6 V, and a current density of 0.8 mA/cm² was used for all tests. The anodes were lithium metal and the electrolyte was 1 M LiPF₆ in Ethylene carbonate: Diethyl Carbonate (EC:DEC) 1:1. The cycle of 2-4.6 V was chosen to allow a direct comparison to the (1-x-y)LiNi_{1/2}Mn_{1/2}O₂.xLi[Li_{1/3}Mn_{2/3}]O₂.yLiCoO₂. Charging to 4.6 V allows for the partial release of Li₂O by the Li₂MnO₃ as discussed hereinabove, which increases capacity while still retaining structural stability. FIGS. 3A and 3B show the capacity plots for the materials. The system showed consistent charge/discharge curves throughout the composition range. Most showed the S-shaped discharge capacity curve that is expected from a varying composition material, and the S approached a gradual linear discharge profile as the composition moves down the diagram. Sample #6 showed a long gradual voltage drop resulting in the highest capacity when discharge to 2V. Some of the other samples show more desirable profile shapes, but Sample #6 is clearly the most promising material from this group. Many of the plots show a kink in the curve approximately half way through the charge cycle, which corresponds to a transition from metal oxidation to lithium extraction accompanied by oxygen loss in the form Li₂O.

TABLE 2 summarizes the initial discharge capacities for various discharge levels in the (1-x-y)LiNi_{0.8}Co_{0.2}O₂.xLi₂MnO₃.yLiCoO₂ system.

TABLE 2

| | | Discharge capacity (mAh/g) | | |
|---|---|---|---|---|
| | | | 4.6-2.75 | |
| Location | Composition | 4.6-3 V | V | 4.6-2 V |
| 1 | Li_{1.033}Mn_{0.067}Ni_{0.640}Co_{0.26}O₂ | 118.4 | 122.4 | 141 |
| 2 | Li_{1.100}Mn_{0.200}Ni_{0.480}Co_{0.220}O₂ | 186.3 | 192 | 208.7 |
| 3 | Li_{1.033}Mn_{0.067}Ni_{0.480}Co_{0.420}O₂ | 177.6 | 184.5 | 201.3 |
| 4 | Li_{1.133}Mn_{0.267}Ni_{0.320}Co_{0.280}O₂ | 171.9 | 177.7 | 191.5 |
| 5 | Li_{1.067}Mn_{0.133}Ni_{0.320}Co_{0.480}O₂ | 177.3 | 183.4 | 199.5 |
| 6 | Li_{1.200}Mn_{0.400}Ni_{0.160}Co_{0.240}O₂ | 189.6 | 203.2 | 229.8 |
| 7 | Li_{1.133}Mn_{0.267}Ni_{0.160}Co_{0.440}O₂ | 166 | 175.4 | 199 |
| 8 | Li_{1.067}Mn_{0.133}Ni_{0.160}Co_{0.640}O₂ | 163.5 | 171.1 | 191.2 |

The outliers of this system in terms of initial discharge capacity are Samples #1 and #6. The lower capacity of Sample #1 may be attributed to synthesis conditions that are not conducive to making a structure with high nickel content. Sample #6 has the highest discharge capacity at every charge level, although Sample #2 has approximately the same capacity at the 3V level which is often taken as the cutoff of a practical cycle. All capacities would be expected to rise if synthesis conditions were optimized for the specific material. Further, as will be described in EXAMPLE 3, hereinbelow, surface treatments such as Al₂O₃ coating or a blending with unlithiated materials may decrease irreversible capacity loss and increase initial discharge capacity. It is apparent that using the high-temperature/quenching synthesis conditions described hereinabove, the best results in both capacity and cost are obtained for compositions high in Mn and low in Co.

### EXAMPLE 2

### Li_{(3+x)/3}Ni_{(1-x-y)}CO_{y}Mn_{2x/3}O₂

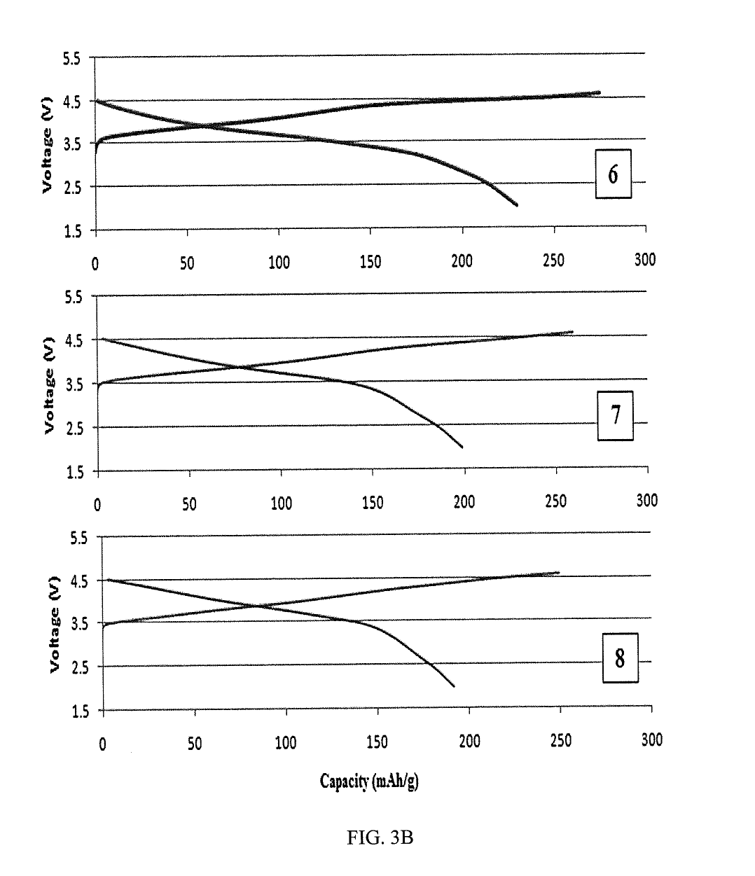

The Li_{(3+x)/3}Ni_{(1-x-y)}Co_{y}Mn_{2x/3}O₂ system is a ternary system with components (1-x-y)LiNiO₂.xLi₂MnO₃.yLiCoO₂. This system was created because it contains every combination of Ni, Co, and Mn when the Mn is in Li₂MnO₃ form. This means that every composition in the previously examined system, (1-x-y)LiNi_{0.8}Co_{0.2}O₂.xLi₂MnO₃.yLiCoO₂, can be represented by a formula in this new representation. Materials in the systems Li_{(4-x)/3}Mn_{(2-x)/3}Ni_{x/3}Co_{x/3}O₂ and (1-x-y)LiNi_{1/2}Mn_{1/2}O₂.xLi[Li_{1/3}Mn_{2/3}]O₂.yLiCoO₂ can only be approximated because they have components containing Mn that is not in the Li₂MnO₃ form. The ternary diagram and the points selected for test are shown in FIG. 4. The preliminary sample points were chosen to make up a simplex centroid design that ensured complete coverage of the composition diagram and could facilitate further mixing modeling if simple trends were observed. Modeling was difficult for the (1-x-y)LiNi_{0.8}Co_{0.2}O₂.xLi₂MnO₃.yLiCoO₂ system because the selection of compositions did not contain points on the boundaries of the diagram, which allowed the projected capacities to approach unreasonably high values or negative values in regions outside of the sample points. The points at the tips and on the sides serve as boundary conditions. The compositions of each sample point in the Li_{(3+x)/3}Ni_{(1-x-y)}Co_{y}Mn_{2x/3}O₂ system are given in TABLE 3.

TABLE 3

| Location | Composition |
|---|---|
| 1 | LiNiO₂ |
| 2 | Li_{1.056}Mn_{0.111}Ni_{0.667}Co_{0.167}O₂ |
| 3 | Li_{1.167}Mn_{0.333}Ni_{0.500}O₂ |
| 4 | LiNi_{0.500}Co_{0.500}O₂ |
| 5 | Li_{1.111}Mn_{0.222}Ni_{0.333}Co_{0.333}O₂ |
| 6 | Li_{1.222}Mn_{0.444}Ni_{0.167}Co_{0.167}O₂ |
| 7 | Li_{1.056}Mn_{0.111}Ni_{0.167}Co_{0.667}O₂ |
| 8 | Li_{1.333}Mn_{0.667}O₂ |
| 9 | Li_{1.167}Mn_{0.333}Co_{0.500}O₂ |
| 10 | LiCoO₂ |

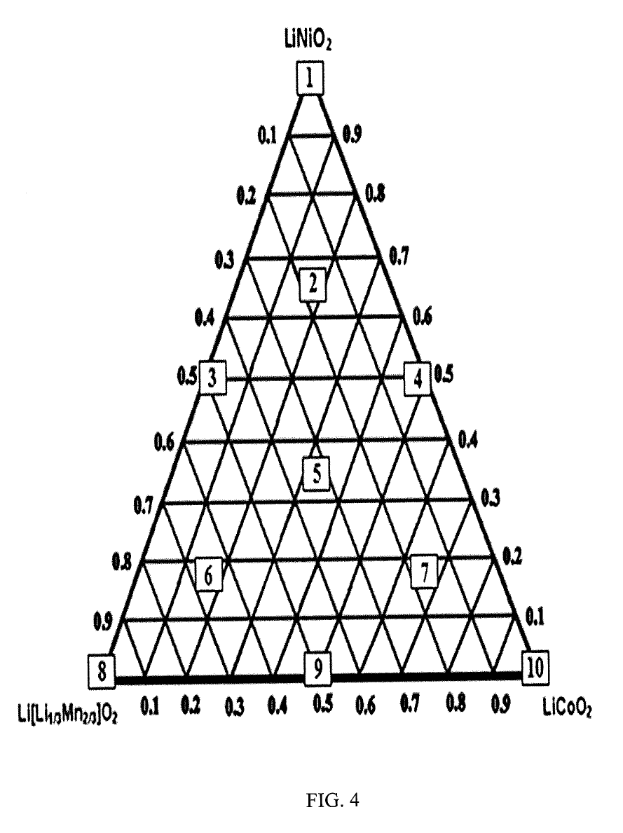

FIG. 5 Shows the quick-scan XRD plots for the Li_{(3+x)/3}Ni_{(1-x-y)}Co_{y}Mn_{2x/3}O₂ system, which show that all samples established an α-NaFeO₂ structure except for Sample #1 which was desired to be LiNiO₂. As described hereinabove, LiNiO₂ requires special synthesis conditions to form that were not met by the constant synthesis conditions used. The XRD curve matches that of NiO, suggesting that possible lithium sublimation occurred at this synthesis condition. The other materials showed the correct peak locations and relative intensities with the exception of Sample #7 which had one extra peak (circled in FIG. 5) and had low intensity values. The extra peak may be attributable to the presence of Co₃O₄ in the material, which may also explain the low capacity value that was measured. Each of the other materials had peaks indexable in the R 3̅m space group.

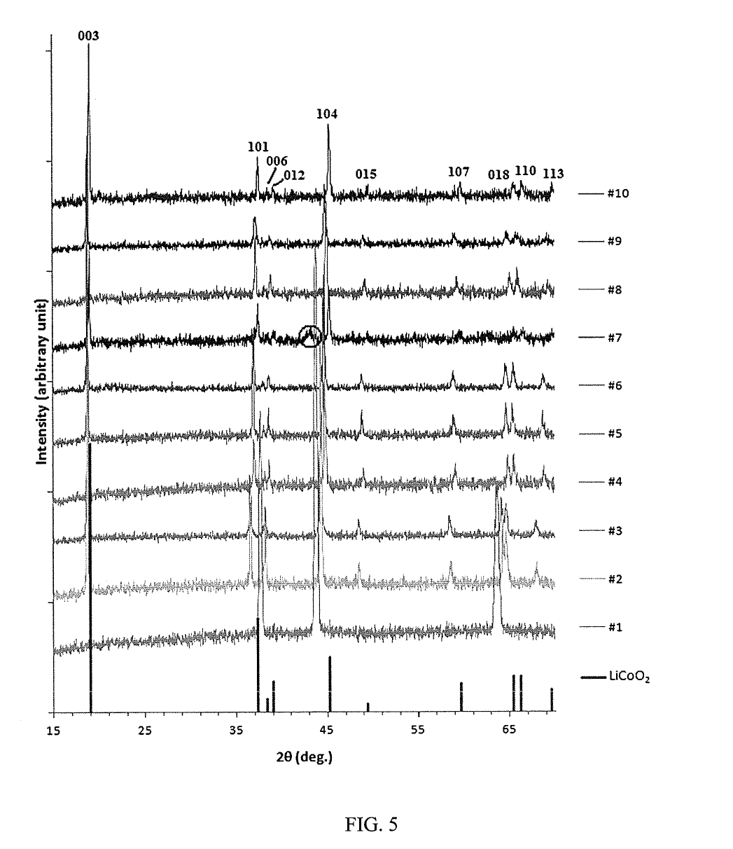

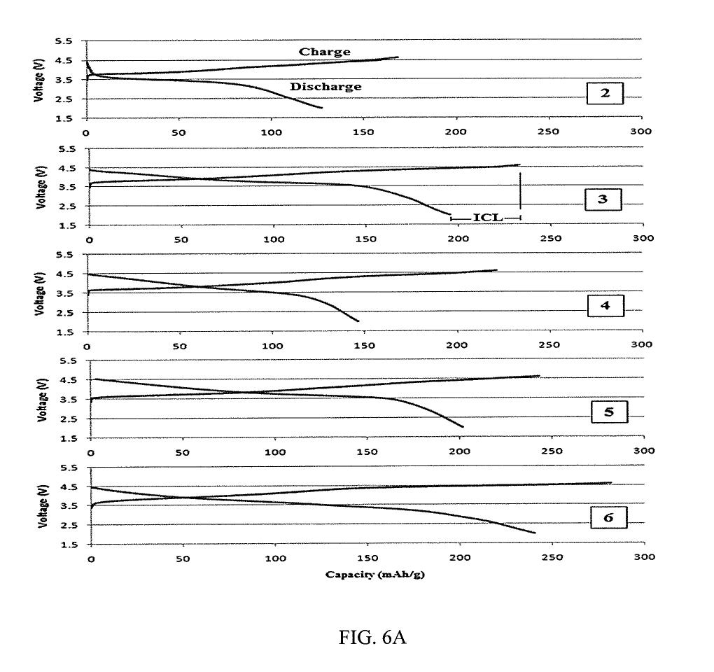

All electrochemical testing was done using an Arbin BT2000 and MITS Pro Arbin software. Cells were cycled between 2 and 4.6 V, and a current density of 0.8 mA/cm² was used for all tests. FIGS. 6A and 6B show the capacity plots for the materials. Sample #1 was not tested due to the poor XRD results. The system is seen to yield a wide range of electrochemical results, most of which show the S-shaped capacity curve that is expected from a varying composition material. Some samples such as Sample #6 showed a long gradual voltage drop resulting in the highest capacity when discharge below 3V, and others such as Sample #5 showed a more constant voltage in the first half of the cycle then a sharp voltage drop. This resulted in Sample #5 having the highest discharge capacity between 4.6 and 3.5 V. Either of these could be better than the other depending on whether the application demands maximum capacity or power quality. That is, some applications such as low power consumer electronics require a constant current at a voltage greater than some low value. These applications are capable of tolerating large swings in voltage without the need for voltage regulation; therefore, most useful materials would have high capacity. Other applications such as electric motors require either a reasonably constant voltage or are operated at constant power. In the former situation, it is desirable to have a narrow voltage window to avoid the requirement of a regulator, while in the latter situation, the current would have to be high in the low voltage region in order to deliver the same power as in the high voltage region. Many of the plots show a kink in the curve approximately halfway through the charge cycle, which corresponds to a transition from metal oxidation to lithium extraction accompanied by oxygen loss in the form of Li₂O. FIG. 7 shows each of the discharge curves plotted together to better compare profiles, and shows that Sample #6 achieves the best overall capacity while the LiCoO₂ Sample #10, has the best voltage profile. Samples #3 and #5 show profiles between Sample #6 and Sample #10. TABLE 4 summarizes the initial discharge capacities for various discharge levels in the Li_{(3+x)/3}Ni_{(1-x-y)}Co_{y}Mn_{2x/3}O₂ system.

TABLE 4

| | | Discharge capacity (mAh/g) | | |
|---|---|---|---|---|
| | | | 4.6-2.75 | |
| Location | Composition | 4.6-3 V | V | 4.6-2 V |
| 1 | LiNiO₂ | N/A | N/A | N/A |
| 2 | Li_{1.056}Mn_{0.111}Ni_{0.667}Co_{0.167}O₂ | 94.8 | 102.8 | 127.1 |
| 3 | Li_{1.167}Mn_{0.333}Ni_{0.500}O₂ | 169.8 | 177 | 195.8 |
| 4 | LiNi_{0.500}Co_{0.500}O₂ | 127.7 | 133.2 | 146.6 |
| 5 | Li_{1.111}Mn_{0.222}Ni_{0.333}Co_{0.333}O₂ | 180.4 | 186.8 | 202.1 |
| 6 | Li_{1.222}Mn_{0.444}Ni_{0.167}Co_{0.167}O₂ | 192.9 | 208.3 | 244.4* |
| 7 | Li_{1.056}Mn_{0.111}Ni_{0.167}Co_{0.667}O₂ | 103.6 | 107.3 | 123.2 |
| 8 | Li_{1.333}Mn_{0.667}O₂ | 54.9 | 67.7 | 95.2 |
| 9 | Li_{1.167}Mn_{0.333}Co_{0.500}O₂ | 137.4 | 152.3 | 186.9 |
| 10 | LiCoO₂ | 154.9 | 159.9 | 180.8 |

*Average of two tests, 240.5 and 248.2 mAh/g

Sample #6 showed the highest initial discharge capacity at each of the major voltage milestones with 240.5 mAh/g at 2V, 208 mAh/g at 2.75V, and 192.9 mAh/g at 3V. The lowest capacity was sample #8, Li₂MnO₃. This was expected because the Mn⁺⁴ ion is inert and the material must rely on oxygen loss to show reversible capacity. All capacities would be expected to rise if synthesis conditions were optimized for the specific materials. Further, surface treatments such as coating with Al₂O₃ or blending with unlithiated materials may decrease irreversible capacity loss and increase initial discharge capacity.

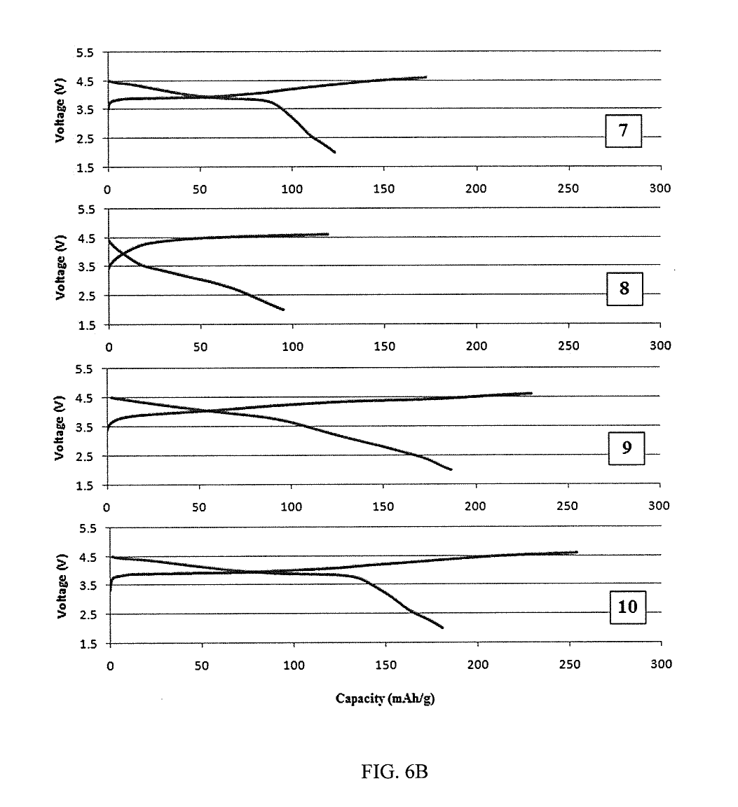

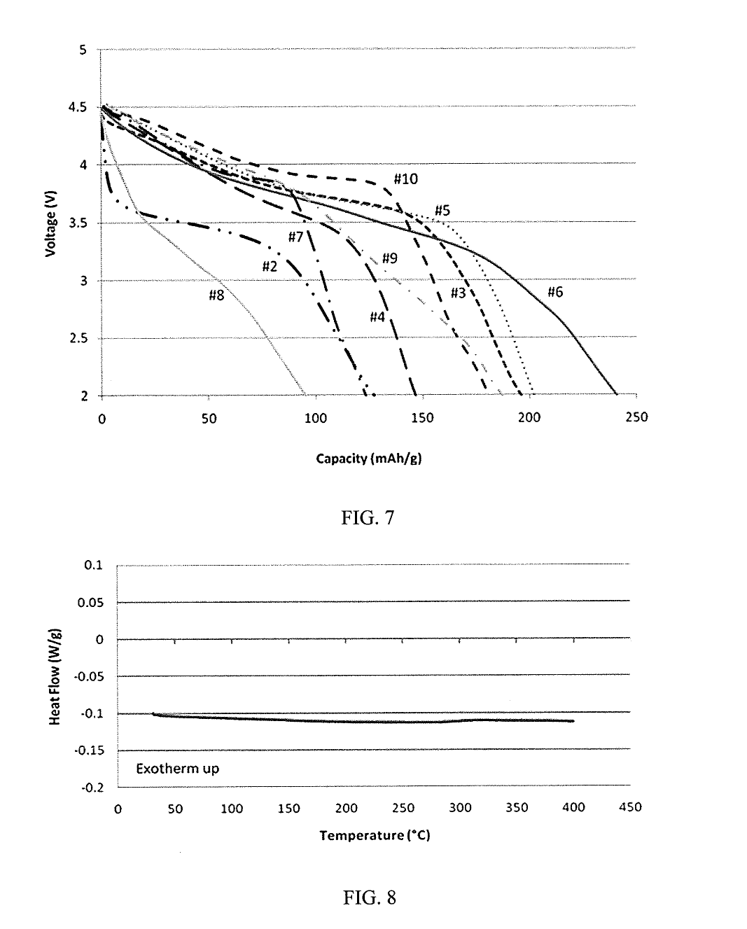

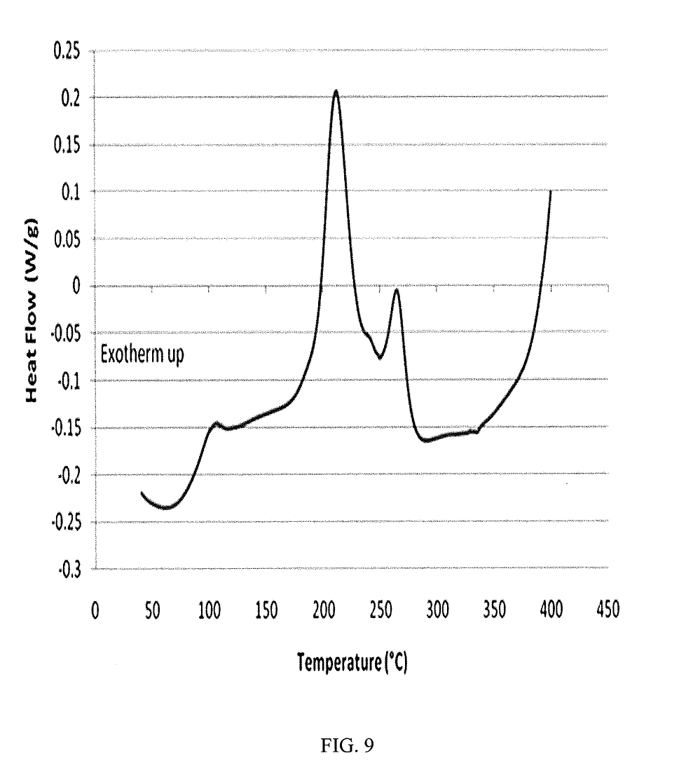

The first step in evaluating the safety of a cathode material is to test the base material alone, before charging and introduction to electrolyte. FIG. 8 shows the differential scanning calorimetry scan for Sample #6 in the uncharged state, illustrating that no exothermic reactions occur in the base material since through the temperature range between 30° C. and 400° C., a heat input is required to raise the temperature. This behavior was expected. A more informative test is a DSC scan of the actual charged cathode material combined with electrolyte. A cell containing the Sample #6 cathode material was charged to 5.0 V, discharged to 3V, then charged to 4.5 V and held there for 40 h while the current dropped to 6 μA. This technique ensures complete charging which is the state where cathodes are most vulnerable to thermally induced exothermic reactions. FIG. 9 shows the DSC results of the charged cathode. The W/g measurement was made using the total mass of the active material, electrolyte, carbon, and binder. The onset of the primary exotherm for the material at temperatures less than 400° C. is at 200° C. This matches the onset for LiNiO₂ and is slightly lower than that of LiCoO₂ at 230° C. The advantage of the material comes with the magnitude of heat flow during the reaction. The maximum of 0.2 W/g is better than LiCoO₂ charged to the same voltage (˜4 W/g) or LiNiO₂ (˜13 W/g). FIG. 10 places this number in perspective by plotting the Sample #6 curve on a heat flow axis along with LiNiO₂ with the same cathode preparation and testing conditions.

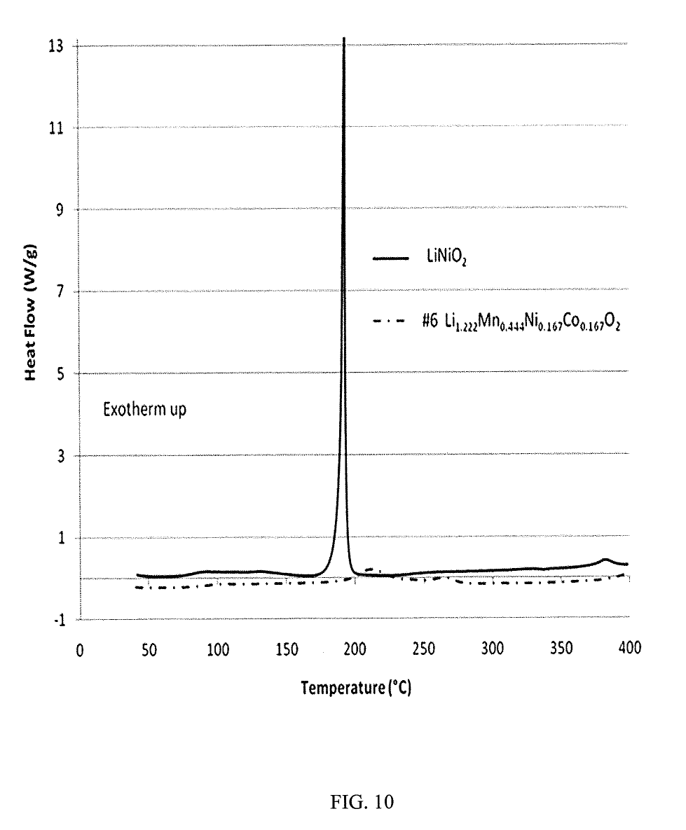

The simplex centroid arrangement of the samples within the system allowed a full cubic mixture model to be fit to the data using a mixture analysis in Minitab software, as will be described hereinbelow. Capacities between 2 and 4.6 V were used, and the results are shown in FIG. 11A. Although this model matches the ten sample points very well, some trends suggest that this is not an adequately accurate capacity map. The maximum capacity of the system is on the diagram border which indicates a better model may be needed. The model also shows very low capacities at points near LiNiO₂ where higher capacities have been found in the past, perhaps because these experiments only used one set of synthesis conditions that may not be optimal for all of the materials in the diagram. If a different set of conditions was used, such as heating in oxygen and slow cooling, it would be expected that the areas near LiNiO₂ would show improvement. To gain higher resolution and improve the trends in the model, the eight points from the (1-x-y)LiNi_{0.8}Co_{0.2}O₂₋ₓLi₂MnO₃.yLiCoO₂ system were converte Li_{(3+x)/3}Ni_{(1-x-y)}Co_{y}Mn_{2x/3}O₂ coordinates and the capacities were used as additional fitting points, which permits the 8 points from the first system to be plotted on the composition diagram for the more general system. The result of this addition is shown in FIG. 11B. Similar qualitative trends in capacity are seen, but a better defined area of maximum capacity, generating a projected “sweet spot” having 238 mAh/g at a composition of Li_{1.20}Mn_{0.41}Ni_{0.23}Co_{0.16}O₂. This projected ideal composition is very close in both capacity and composition to the “master” #6 sample, which suggests that Sample #6 may be close to ideal for the given synthesis and testing conditions, and future compositions tested should be focused around this point.

### EXAMPLE 3

### Metal Oxide Coatings:

Li_{1.222}Mn_{0.444}Ni_{0.167}Co_{0.167}O₂ has been identified hereinabove as high performance material. In what follows, the surface of this material has been modified by coating with different metal oxides (MO) [MO=Al₂O₃, AlPO₄, ZnO, CeO₂, ZrO₂, or SiO₂], which showed improvement in electrochemical performance. Coating of metal oxides was performed by a solution based method. Li_{1.222}Mn_{0.444}Ni_{0.167}Co_{0.167}O₂ was dispersed in a solution of corresponding metal nitrates (Al(NO₃)₃, Zn(NO₂)₂, Zr(NO₃)₂, NH₄Ce(NO₃)₆, (NH₄)₂PO₄) and SiC₈H₂COO₄ (as a Si source) in deionized water, and stirred for 20 min. AlPO₄ coatings were generated utilizing aluminum nitrate and diammonium phosphate as precursors. Ammonium hydroxide solution was then dropwise added to the solution under stirring to precipitate the corresponding metal hydroxides, and coated powder was recovered by filtration and dried overnight. These samples were further annealed at 350° C. (for Al₂O₃, ZnO, ZrO₂, SiO₂), 500° C. (for CeO₂), or 700° C. (for AlPO₄) for 4 h to convert hydroxides into metal oxides.

Phase purity and crystal structure details were examined by Scintag X-ray diffraction using Cu-K1 radiation. The samples were hermetically sealed in aluminum pans and heated to the desired temperature at a ramp rate of 10° C./min. The cathode material was held at charged conditions (4.6 V for 40 h until the current dropped to minimum values). The cathode was recovered in an Argon atmosphere, the excess electrolyte was removed, and the sample was hermetically sealed in an Aluminum pan for DSC testing. This procedure ensures complete charging, which is the state where cathodes are most vulnerable to thermally induced exothermic reactions.

Li_{1.222}Mn_{0.444}Ni_{0.167}Co_{0.167}O₂ was mixed with conducting carbon and PTFE in a 75:20:5 ratio before being rolled into thin sheets. A thin sheet of lithium metal was used as the anode. The electrolyte was 1M LiPF₆ [EC: DEC 1:1 by volume]. A Celgard 2340 membrane was used as the separator material. The cells were assembled in a VAC atmosphere glove box under high purity Ar gas, and were tested using an Arbin cycler in galvanostatic mode under constant current (0.1 mA/cm²) between 4.6 V and 2V.

In order to confirm the presence and quality of coating both SEM and TEM were performed. SEM provides the microstructural details of the particles, which were found to have well defined morphology and submicron size. However, the presence of a thin layer of coating (approximately 10-20 nm) was observed by TEM. XPS was performed to determine the valence states of transition metals as well as to establish the presence of desired coating on the surface of the material. The chemical environments of transition metals Ni, Mn, and Co in the uncoated materials, as well as coated metals, were determined based on the binding energy positions of elements in the XPS spectra. The C 1s peak was observed at 285 eV. The O 1s spectra showed a peak around 531 eV, which is consistent with the literature. The binding energy of Li 1s is at 54 eV which is consistent with reported values. In Li(NiₓCo₁₋₂ₓMnₓ)O₂, the valence states of Ni, Co, and Mn were determined to be 2+, 3+and 4+, respectively. The Co peak has a doublet [Co 2p_{3/2} and Co 2p_{1/2}, at ˜780 and ˜795 eV, respectively, with binding energy separation of 15 eV) indicative of Co³⁺. Peaks of Ni ion appear with satellite peaks (Ni 2p_{3/2} and Ni 2p_{1/2}) due to electronic transitions arising in out of energy level splittings. The binding energy separation between Ni peaks is about 18 eV. Mn ions also showed peak splitting corresponding to Mn 2p_{3/2} and 2p_{1/2} transition with the former at ˜644 eV, representative of the +4 valence state as known from the literature. The results that the predominate oxidation states of Ni, Co, and Mn in the compound are +2, +3 and +4, respectively, are in agreement with the literature. Regarding the metal oxide-coated samples, the peak of Al 2p at ˜73 eV is evidence that Al in Al₂O₃ is present at the surface of the core particle and consistent with literature. For samples coated with AlPO₄, the binding energy observed for Al 2p at ˜73 eV and that of P at ˜133 eV are consistent with AiPO₄-coated Li(Ni_{0.8}Co_{0.2}O₂). Similarly coated sample results for ZrO₂, ZnO, SiO₂ and CeO₂ indicate the presence of respective metal oxide coating with tetravalent states for Zr, Si, and Ce, and a divalent state for Zn, respectively, on the samples.

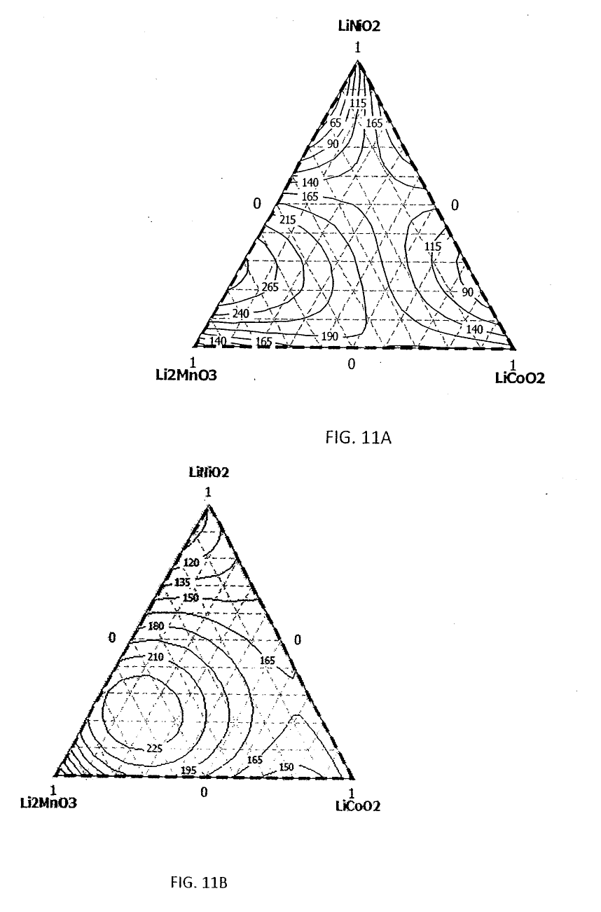

The three best performing coatings were Al₂O₃, ZnO and AlPO₄. FIG. 12 shows the first discharge profile of these materials, with FIG. 12(a) illustrating the initial discharge performance of Al₂O₃-coated Li_{1.222}Mn_{0.444}Ni_{0.167}Co_{0.167}O₂ which illustrated a flat profile with mid-V_{oc} (midpoint open-circuit voltage) at approximately 3.8 V. Of interest is the performance of Al₂O₃ and ZnO materials (the best discharge capacities in the series) under high voltage conditions (up to 4.95 V), which results are presented in FIGS. 12(a)-12(c). When Al₂O₃-coated materials are charged to 4.8 V, the capacity increased to 265 mAh/g, which was maintained in the second cycle. When the charging voltage was increased to 4.95 V, the capacity further increased to 275 mAh/g. Overall increase in the charge voltage resulted in a gain of 21 mAh/g. Similar improvements were observed for ZnO-coated materials (FIG. 12(b)). It is noteworthy that the best performance was for the ZnO coated materials (FIG. 12(b)), and that the best performance was for the ZnO, which was about 282 mAh/g when charged to 4.95 V. FIG. 12(c) shows the first discharge profile of Al₂O₃, ZnO, and AlPO₄-coated materials which showed capacities around 250 mAh/g.

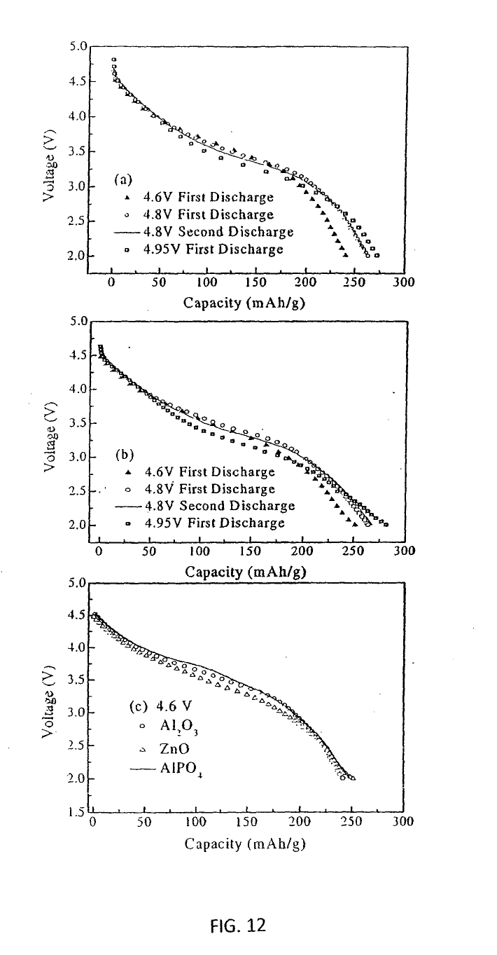

With 4.6 V as a cutoff, the best performing materials, namely Al₂O₃, AlPO₄, and ZnO, were subjected to extended cycle life testing and the results are shown in FIG. 13. Initial cycles were tested at 0.1 mA/cm² and the remaining cycles were tested at three times the current density. Al₂O₃ performed well compared to ZnO in terms of maintaining capacity at extend life (up to 40 cycles). The effect of MO coating is pronounced in reducing e ICL. For example, the ICL associated with uncoated sample is about 38 mAh/g (282-244 mAh/g). On coating with Al₂O₃, the first charge capacity was reduced to 262 mAh/g and the discharge capacity to 254 mAh/g, resulting in an ICL loss of about 8 mAh/g. This reduction in ICL may be the result of the surface modification of the cathode material as a result of Al₂O₃ coating. Significant reduction in ICL was observed for other samples also. The corresponding numbers for AlPO₄, SiO₂, ZnO, ZrO₂, and CeO₂ are 15, 15.4, 16.9, 2, and 27.5 mAh/g, respectively. Although the ZrO₂-coated sampled did not improve the discharge capacity, it has minimum ICL, showing the effect of such coatings.

Electrochemical performance of the coated samples show the following results: a) Coating reduced the ICL loss and enhanced the discharge capacity under identical testing conditions with extended cyclability; b) Charging to higher voltages beyond 4.6 V showed a slight improvement in the discharge capacity; and c) some coatings did not perform as well as others. The improvement in electrochemical performance of MO coated materials (Al₂O₃, AlPO₄, and ZnO) may be attributed to minimizing the electrode-electrolyte interfacial reaction, thereby preventing the oxidation of the electrolyte. The metal oxide layers provide a physical separation of the electrode material from the electrolyte, and helped to decrease the catalytic surface of the material that is in contact with the electrolyte. Such “passivation layer” coatings likely minimize the irreversible loss of oxygen from the lattice leading to a non-desirable lowering of the valence state of transition elements such as Ni, Mn, and Co. Investigations by others of the mechanism of improved electrochemical performance of coated LiCoO₂ materials, attribute the improvement, not only due to eliminating the dissolution of lithium from LiCoO₂, but also due to the suppression of oxygen formation. The surface modification can prevent the formation of oxygen atoms with higher oxidizing power allowing higher changing voltages and improved the electrochemical performance. Further, metal oxide coatings may provide stable and lower charge transfer resistance between the cathode and the electrolyte. Combination of the above factors may account for the observed improvement in electrochemical performance. Non-improvement in the discharge capacity for CeO₂ and ZrO₂ indicate insufficient surface modification, possibly due to non-optimum surface area.

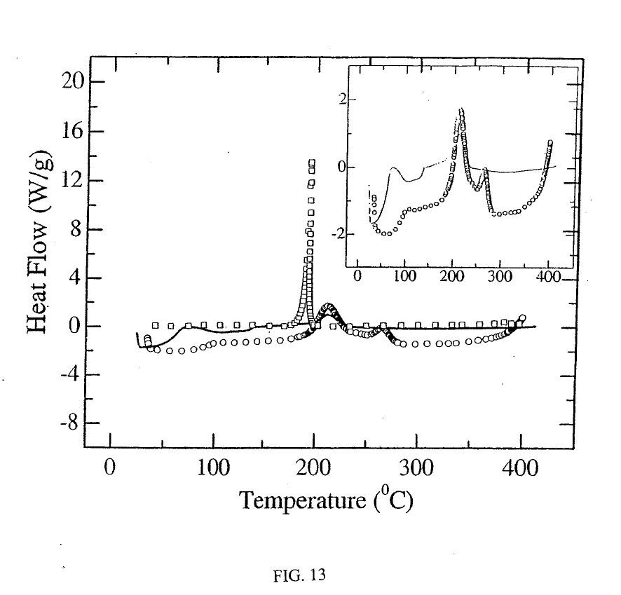

The first step in evaluating the safety of the cathode materials is to test the base material alone before charging and after introduction of electrolyte. DSC showed that no exothermic reaction occurs in the base material in the temperature range 20-350° C. This behavior was expected, and any other result would make this material unstable. A more informative test is a DSC scan of the charged material combined with electrolyte. Following the literature procedure DSC experiments were performed on the charged cathode and presented the results in FIG. 14. The W/g measurements were made using the total mass of the active material, electrolyte, carbon and binder. The onset of the primary exotherm is at 210° C. which is greater than the temperature onset for LiNiO₂. There is a secondary isotherm observed at 260° C. for uncoated material. In addition, DSC resulted showed the magnitude of the isotherm is small. For example, the maximum of 0.2 W/g for uncoated Li_{1.222}Mn_{0.444}Ni_{0.167}Co_{0.167}O₂ is significantly smaller than LiCoO₂ tested under same condition (˜4 W/g) or LiNiO₂ (˜13 W/g). DSC of the Al₂O₃-coated Li_{1.222}Mn_{0.444}Ni_{0.167}Co_{0.167}O₂ material was performed, which showed an exothermic peak at 210° C. The magnitude of heat flow has decreased even further and the secondary exotherm observed for the uncoated material around 260° C. is completely eliminated. The results strongly suggest that coating Li_{1.222}Mn_{0.444}Ni_{0.167}Co_{0.167}O₂ particles improved the thermal stability of the materials.

In summary, lithium-ion cathode material in the systems (1-x-Y)LiNi_{0.8}Co_{0.2}O₂.xLi₂MnO₃.yLiCoO₂ and (1-x-y)LiNiO₂.xLi₂MnO₃.yLiCoO₂ (Li_{(3+x)/3}Ni_{(1-x-y)}Co_{y}Mn_{2x/3}O₂) has been studied. Inexpensive solid state synthesis was used for all materials, and XRD verified that all samples had the layered α-NaFeO₂ structure. Electrochemical results for the chosen compositions within each system showed wide variance in initial discharge capacity as the composition was changed. In both systems, compositions rich in nickel showed lower capacities. This may be the result of limitations of the compositions, but may also be due to the fact that heating in air and quenching is not conducive to the proper formation of materials close to LiNiO₂. The highest observed capacities for the (1-x-y)LiNi_{0.8}Co_{0.2}O₂.xLi₂MnO₃.yLiCoO₂ and Li_{(3+x)/3}Ni_{(1-x-y)}Co_{y}Mn_{2x/3}O₂ systems were 229.8 and 248.2 mAh/g, respectively.

In DSC testing, the charged cathode material containing Li_{1.222}Mn_{0.444}Ni_{0.167}Co_{0.167}O₂ material that achieved 248.2 mAh/g also showed a very small exothermic reaction of 0.2 W/g at 200° C., which is an improvement over LiCoO₂. If this material shows adequate cycling and power characteristics, the capacity will make the material useful without further optimization. Higher capacities are expected from other compositions and by optimizing the synthesis process for the material.

A preliminary cost of materials analysis revealed laboratory scale costs of $0.36/gram and $1.47/Ah for the best material. These values are expected to decrease by a factor of ten when purchased in bulk, and the cost of this material is lower than that of LiCoO₂ due to the higher discharge capacity and the cost savings of reduced cobalt content.

The data from both systems were compiled and fit to a full cubic model in order to map the capacities across the ternary diagram in search for materials having higher capacities. A model fit to only the Li_{(3+x)/3}Ni_{(1-x-y)}Co_{y}Mn_{2x/3}O₂ results revealed a capacity map with a maximum predicted capacity at the boundary of the diagram. This suggested an insufficient number of data points, whereby the points from the (1-x-y)LiNi_{0.8}Co_{0.2}O₂.xLi₂MnO₃.yLiCoO₂ system were added. This resulted in a qualitative “sweet spot” with 238 mAh/g at a composition of Li_{1.20}Mn_{0.41}Ni_{0.23}Co_{0.16}O₂. The projected best composition is close in both capacity and composition to the “master” #6 sample.

Li_{1.222}Mn_{0.444}M_{0.167}Co_{0.167}O₂ material coated with metal oxides, showed a decreased ICL resulting in an improvement in the specific capacity (244-254 mAh/g). Out of the six metal oxides tested (Al₂O₃, AlPO₄, SiO₂, ZnO, ZrO₂, and CeO₂), the best performance was for Al₂O₃-coated material. When Al₂O₃ and ZnO-coated materials were subjected to extended voltage range (4.8 and 4.95 V) testing, ZnO showed a further increase in capacity up to 282 mAh/g (at 0.1 mA/cm2). DSC results of uncoated materials showed a low magnitude exotherm peak at 210° C. and at 260° C. and the Al₂O₃-coated material showed further reduced exotherm at 210 ° C. with compete elimination of peak at 260° C. The results showed the effect of an Al₂O₃ coating in controlling thermal stability, which may minimize the particle-electrolyte site reactions at high voltage, improve the interface, minimize ICL, and increase the specific discharge capacity of the materials.

Optimization of material characteristics may be achieved using the steepest ascent method which incorporates response surface analysis. Sample #6 may be used as a starting point, with “x” and “y” being the parameters. Ranges of x and y are then chosen so that there is an variation of the capacity in the range which is approximately linear with the x,y values. The “steepest ascent path” can then be calculated which is the direction of the fastest increase in capacity. When a local maximum is found, this process is repeated until the local maximum is close to the previous point from which a response surface that models the capacity for a relatively small region around the new point is created. The method fits a polynomial equation to the region to determine the point in the system having maximum capacity. New criteria can also be developed to locate the best combinations of capacity, stability, cycle life, etc., as is explained in the links: http://www.minitab.com/support/documentation/answers/Path%20of%20Steepest%20Ascent,%20 Descent.pdf and http://www.weibull.com/DOEWeb/response_surface_methods.htm.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A composition of matter comprising a ternary material having the chemical formula: (1-x-y)LiNiO₂.xLi₂MnO₃.yLiCoO₂, where x+y≦1, x≦1, and y≦1.

2. The composition of matter of claim 1, wherein the ternary material is coated with a metal oxide coating.

3. The composition of matter of claim 2, wherein the metal oxide is chosen from Al₂O₃, AlPO₄, ZnO, CeO₂, ZrO₂, and SiO₂.

4. The composition of matter of claim 1, wherein x=0.666, and y=0.167.

5. The composition of matter of claim 1, further comprising at least one dopant chosen from Al, Mg, Zr, Ti, Sn, and Cu.

6. A composition of matter consisting essentially of a ternary material having the chemical formula: (1-x-y)LiNiO₂.xLi₂MnO₃.yLiCoO₂, where x+y≦1, x≦1, and y≦1.

7. The composition of matter of claim 6, wherein the ternary material is coated with a metal oxide coating.

8. The composition of matter of claim 7, wherein the metal oxide is chosen from Al₂O₃, AlPO₄, ZnO, CeO₂, ZrO₂, and SiO₂.

9. The composition of matter of claim 6, wherein x=0.666, and y=0.167.

10. A cathode comprising an active material consisting essentially of a ternary material having the chemical formula (1-x-y)LiNiO₂.xLi₂MnO₃.yLiCoO₂, where x+y≦1, x≦1, and y≦1.

11. The cathode of claim 10, wherein the ternary material is coated with a metal oxide coating.

12. The cathode of claim 11, wherein the metal oxide is chosen from Al₂O₃, AlPO₄, ZnO, CeO₂, ZrO₂, and SiO₂.

13. The cathode of claim 10, further comprising a conductive additive and a binder.

14. The cathode of claim 13, wherein the conductive additive comprises carbon black.

15. The cathode of claim 13, wherein the binder is chosen from polyvinylidene fluoride and polytetrafluoroethylene.

16. A cathode consisting essentially of an active ternary material having the chemical formula: (1-x-y)LiNiO₂.xLi₂MnO₃.yLiCoO₂, where x+y≦1, x≦1, and y≦1, a conductive additive, and a binder.

17. The cathode of claim 16, wherein the ternary material is coated with a metal oxide coating.

18. The composition of matter of claim 17, wherein the metal oxide is chosen from Al₂O₃, AlPO₄, ZnO, CeO₂, Zr0₂, and Si0₂.

19. The cathode of claim 16, wherein the conductive additive comprises carbon black.

20. The cathode of claim 16, wherein the binder is chosen from polyvinylidene fluoride and polytetrafluoroethylene.

21. A cathode comprising an active material comprising a ternary material having the chemical formula (1-x-y)LiNiO₂.xLi₂MnO₃.yLiCoO₂, where x+y≦1, x≦1, and y≦1.

22. The cathode of claim 21, wherein the ternary material further comprises at least one dopant chosen from Al, Mg, Zr, Ti, Sn, and Cu.

23. The cathode of claim 21, wherein the ternary material is coated with a metal oxide coating.

24. The cathode of claim 23, wherein the metal oxide is chosen from Al₂O₃, AlPO₄, ZnO, CeO₂, ZrO₂, and SiO₂.

25. The cathode of claim 21, further comprising a conductive additive and a binder.

26. The cathode of claim 25, wherein the conductive additive comprises carbon black.

27. The cathode of claim 25, wherein the binder is chosen from polyvinylidene fluoride and polytetrafluoroethylene.

28. A method for preparing active ternary cathode materials having the chemical formula (1-x-y)LiNiO₂.xLi₂MnO₃.yLiCoO₂, where x+y≦1, x≦1, and y≦1, comprising the steps of:
mixing stoichiometric quantities of acetates of lithium, manganese, nickel and cobalt;
grinding the mixture of acetates to a chosen particle size;
heating the mixture to a first temperature effective for decomposing the acetates;
after allowing the heated mixture to cool, grinding the cooled mixture to a homogeneous powder;
pressing the powder into a pellet;
heating the pellet to a second temperature effective for phase formation, and low enough to avoid decomposition; and
quenching the heated pellet in liquid nitrogen.

29. The method of claim 28, wherein the acetates of lithium, manganese, nickel and cobalt comprise: Li—(COOCH₃)₂.2H₂O, Mn—(COOCH₃)₂.4H₂O, Ni—(COOCH₃)₂.4H₂O, and Co—(COOCH₃)₂.4H₂O.

30. The method of claim 28, wherein said first temperature is approximately 450° C.

31. The method of claim 28, wherein said second temperature is approximately 975° C.

32. The method of claim 28, further comprising the steps of:
grinding the pellet;
sieving the ground particles to ensure a chosen maximum particle size;
mixing the sieved particles with a conductive additive;
adding a binder to the mixture of sieved particles and conductive additive; and
drying the resulting mixture.
